(19) United States
(12) Patent Application Publication
(10) Pub. No.: US 2010/0210376 A1
(43) Pub. Date: Aug. 19, 2010

(54) LONG LASTING GOLF TEE

(76) Inventor: James Paul O'Sullivan, SR., LEESBURG, FL (US)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/540,887

(22) Filed: Aug. 13, 2009

Related U.S. Application Data
(60) Provisional application No. 61/207,793, filed on Feb. 18, 2009.

(51) Int. Cl. A63B 57/00; B23P 11/00

(52) U.S. Cl. 473/401; 29/428

(57) ABSTRACT

A long lasting golf tee for use when striking a golf ball with a golf club. The long lasting golf tee includes a shank having a ground insertion tip at one end and a golf ball support structure at the other end, the shank formed of a member selected from the group consisting of aluminum and its physical equivalents for the intended purpose; an enlargement positioned so as to encircle the shank below the golf ball support structure and located so as to be struck by a clubface of a golf club after the golf ball has been struck from the golf ball support structure, the enlargement having a diameter and a thickness; wherein the diameter of the enlargement is larger than that of the golf ball support structure and smaller than the diameter of the golf ball, the thickness of the enlargement along the shank being less than the diameter; the enlargement being substantially elastic and having a resistance to compression sufficient to prevent the clubface of the golf club from impacting the golf ball support structure. A method of making a long lasting golf tee is also provided.

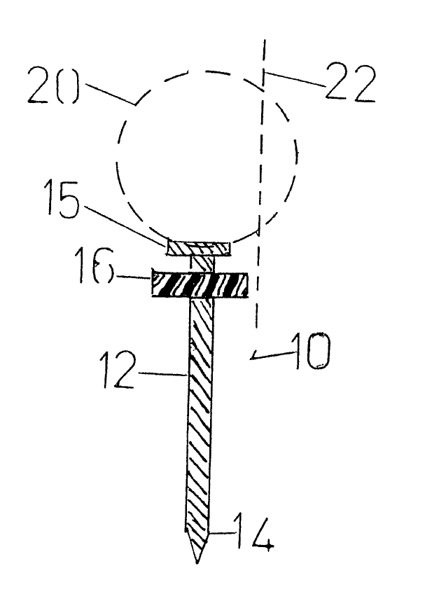

### RELATED APPLICATION

This patent application claims priority to Provisional Application Ser. No. 61/207,793, filed on Feb. 18, 2009, the contents of which are hereby incorporated by reference in their entirety.

### FIELD

This document relates to the field of golf and, in particular, to golf tees for use when striking a golf ball with a golf club.

### BACKGROUND

In all of golf, the least technically studied aspect thereof is the golf tee. Still, it has evolved from a mound of dirt or sand, through wooden tees, to plastic and metal tees. What has not developed, because tees are probably the least expensive equipment part of the game, is a truly long lasting tee. By long lasting herein is meant anywhere from 50 to more than a hundred or more rounds of golf. True conventional golf tees are inexpensive in one sense but are expensive in the sense of being wasteful of trees and other raw material and unsightly in littering golf teeing areas. There is a place in golf for a long lasting golf tee and it is high time for one.

The tees disclosed herein must, obviously, be useable numerous times, not be harmful to any part of the club, particularly the club face, be of a size to accommodate the club striking the ball in the center of the present day larger club face and have the tee remain either in the ground or in the nearby teeing area after ball contact. To be a long lasting tee, it must not be damaged by the strike of the modern titanium or steel faced clubs. The tees disclosed herein are made of aluminum or its functional equivalent for the intended purpose and, therefore, cannot under normal circumstances harm titanium- or steel-faced clubs. However, the reverse is not true. Titanium- or steel-faced clubs can and do distort and mangle the few aluminum tees that are on the market.

The one vulnerable part of an aluminum tee is the periphery of the ball support area. The soft aluminum is easily distorted and mangled after only a few ball strikes and in short order the ball support area is unusable.

As will be disclosed hereinbelow, this problem has been solved by locating an intercepting member of a natural- or man-made material of a particular size and of a particular shape on the tee at a point where, after a struck ball has departed the tee, the intercepting member absorbs the force of the of the club face strike and is compressed, but not enough to permit the club face to contact the ball support periphery and rebound to its original shape. All this happens in the microsecond after the ball has been struck off the tee. As a result, the aluminum or its equivalent tee material never gets distorted or rendered unusable in the ball support periphery area.

Design Patent No. Des. 425,155 is directed to a GOLF FEE WITH A PROTECTIVE PAD. The patent shows a golf tee of conventional shape having a ring of some material about the periphery of the ball support area.

Tees purporting to be covered by Design Patent Des. 425,155 are sold in a package of 5 tees under the name HI+PER+TEES. A black rubber O-ring is set in a groove at the periphery of the ball support region of the tee. The outside diameter of the ring is slightly more than about ½inch. The cross section of the ring material measures between ⅛th and 1/16th of an inch. While the exact hardness of the rubber is not known, a thumbnail can easily press the rubber in to touch the periphery of the ball support area of the tee. The tee is said to be made of “aircraft grade aluminum”. Testing of such tees has revealed that, after each tee shot, using a titanium-faced driver and a swing speed of no more than 85 mph, the rubber O-ring was easily compressed enough to leave an indent in the periphery of the ball support area. At the end of eighteen holes the periphery of the ball support member was flattened and distorted with each clubface strike. It therefore is obvious that this cannot be termed a long lasting golf tee.

U.S. Pat. No. 1,551,003 proposes a tee having a metal shank, the metal typified by phosphor bronze (typically a copper, with 3-10% tin and up to 1% phosphorous) carrying a molded India rubber head for supporting a golf ball. These tees are intended to be tether-restrained to a teeing area.

U.S. Pat. No. 1,588,038 proposes a golf tee shank having a detachable head of a color distinguishable from that of the golf fairway.

U.S. Pat. No. 1,627,012 proposes a golf tee seemingly very similar to Design Patent No. Des. 425,155, supra. U.S. Pat. No. 1,627,012 tee structure would be expected to suffer from the same technical shortcomings as the product sold under the name HI+PER+TEES.

U.S. Pat. No. 1,670,123 proposes a golf tee made of wood. Its object is to provide a flexible collar or sleeve of rubber de-mountably attached to the tee in combination with a tethering cord attached to a weight. This wood tee can have an unidentified metal shank (see page 2, col. 2 line 101. It is not believed that a small collar of a 1928 vintage rubber could effectively protect a wood ball support for very long.

U.S. Pat. No. 1,679,579 proposes a two piece tee, the upper part detachable and flexible and the lower part can be re-loaded with a new upper ball support part.

U.S. Pat. No. 3,645,537 proposes a golf tee having a flexible horizontal disc having a ball-receiving recess; an inverted elongated metal cone; and a vertical spongy cylinder disposed and connected between the disc and the cone.

U.S. Pat. No. 5,186,455 proposes a double sleeve arrangement to protect the shank of a wooden tee.

U.S. Patent Application Publication No. 2006/0223655proposes a tee made exclusively of wood with a flat head having a ball supporting depression therein and a structure which tapers to a tee-ground insertion point.

Despite advances in the art, there is still a need, for a long lasting golf tee that overcomes the shortcomings of prior designs.

### SUMMARY

In one aspect, disclosed herein is a long lasting golf tee for use when striking a golf ball with a golf club. The long lasting golf tee includes a shank having a ground insertion tip at one end and a golf ball support structure at the other end, the shank formed of a member selected from the group consisting of aluminum and its physical equivalents for the intended purpose; an enlargement positioned so as to encircle the shank below the golf ball support structure and located so as to be struck by a clubface of a golf club after the golf ball has been struck from the golf ball support structure, the enlargement having a diameter and a thickness; wherein the diameter of the enlargement is larger than that of the golf ball support structure and smaller than the diameter of the golf ball, the thickness of the enlargement along the shank being less than the diameter; the enlargement being substantially elastic and having a resistance to compression sufficient to prevent the clubface of the golf club from impacting the golf ball support structure.

In one form, the shank comprises aluminum.

In another form, the aluminum comprises an alloy of primarily aluminum.

In yet another form, the enlargement comprises a resilient material.

In still yet another form, the resilient material comprises a natural or man-made resilient material.

In a further form, the resilient material is neoprene.

In a still further form, the resilient material has a hardness of from about 30 to about 90 durometer.

In a still yet further form, the neoprene has a hardness of about 50 to about 60 durometer.

These and other features will be apparent from the detailed description taken with reference to the accompanying drawing.

### BRIEF DESCRIPTION OF THE DRAWING

Further explanation may be achieved by reference to the description that follows and the drawing illustrating, by way of a non-limiting example, wherein:

The FIGURE is a side view of a long lasting golf tee in accordance herewith shown with a golf ball 20, in phantom lines, mounted thereon.

### DETAILED DESCRIPTION

Various aspects will now be described with reference to specific forms selected for purposes of illustration. It will be appreciated that the spirit and scope of the golf tees disclosed herein are not limited to the selected forms. Moreover, it is to be noted that the figure provided herein is not drawn to any particular proportion or scale, and that many variations can be made to the illustrated forms. Reference is now made to the FIGURE.

### DEFINITIONS

By “long lasting” herein is meant anywhere that a golf tee may be used from about fifty to about one hundred or more rounds of golf.

By a material being “substantially elastic” is meant that the material possesses a springing back or inherent property of essentially returning to the form from which the material was bent, pressed or twisted.

Disclosed herein is a long lasting golf tee comprising a structure of a member selected from the group consisting of aluminum and any other non-fractural material incapable on impact of marring the face of a titanium or steel face golf club, the structure has a shank with a ball support head at one end and a teeing area insertion point at the other; and below the head, encircling the shank is a resilient ball support protection member of a diameter and a thickness sufficient to prevent impact distortion of the head.

Referring now to the FIGURE, a ball 20 is mounted on tee 10, having a shank 12 with a teeing ground insertion point 14 at one end and a golf ball support cup 15 at the other. Mounted on the shank, just below or a short distance below golf ball support cup 15, is a shank enlargement member 16. Shown by dotted lines 22 is an approximate compression point where a golfer of the caliber of a Tiger Woods would be expected to compress a ball during a drive off the tee. The width of the shank enlargement member 16 is critical. The width must be greater than the outer diameter of the golf ball support cup in order to prevent club impact and ultimate distortion of the golf ball support cup and the rendering of its reliable use unfit. The width of the enlargement member also must be less than the diameter of a golf ball. This insures that a struck ball will leave the ball support before the clubface can strike the shank enlargement.

The tee disclosed herein can be made of two materials, the first, aluminum, or its functional equivalents, for the tee shank, tee point and ball support cup and the second for the shank enlargement, a material of a size and property having resilient compression strength great enough to prevent the face of a titanium or steel club from impacting the periphery of the ball support cup. In a publication by Northern Lites™Inc., 1000 Fourth Avenue W.N., Columbia Falls, Mont., 59912 (406-253-7055), in an article entitled “Aircraft Aluminum,” written by Penny Jo Wagner, in Race & Rally magazine, winter 1995, page 18, aluminum and its common alloys are described. Any of these aircraft aluminum alloys can be used herein.

### EXAMPLES

### Example 1

Aluminum gutter spikes were obtained from Amerimax Home Products, Inc., 450 Richardson Dr., Lancaster, Pa., 17603-4036. These spikes have a 7/32 inch diameter shank, a 7/16 inch diameter nail head and are about 8 inches long. The shanks have herringbone score lines about most of the circumference thereof. These spikes are normally used to attach rain gutters to homes and other buildings.

One of the spikes was cut to 4 inches and provided with a concavity in the nail head sufficient to support a golf ball. The opposite end was provided with a taper to accommodate teeing ground insertion. This tee was tested over more than 5 rounds of golf. Examination of the tee revealed only slight bending of the shank but progressive damage to the periphery of the ball support region. From this it was clear that with the progressive damage to the tee cup, the tee could not be termed a long lasting golf tee.

With reference to the FIGURE herein and visualizing slow motion contact of a titanium face driver on a ball on the tee of the example, it is clear that the first thing to occur is that the ball departs the tee and the second is that the club face strikes the periphery of the ball support cup, imparting a significant flattening of the aluminum periphery and the beginning of a decrease in the area of the ball support. In comparatively short order the support cup will be rendered unfit for use.

To overcome this problem, a shank enlargement was placed on the shank just below the ball support cup. The diameter of the cup is ⅜ inch. The diameter of the enlargement is greater than the diameter of the ball support cup, i.e., ¾ inch and less than the diameter of a golf ball, i.e., less than 1⅝ inches. The enlargement of the shank must be elastic and have an appropriate durometer number or value and have sufficient resistance to compression, so as to prevent the force of the clubface from deleteriously acting on the periphery of the ball support cup. The elasticity of the enlargement material will return it to its original shape, permitting its use in many rounds of golf without any damage to the ball support cup. This is illustrated in Example 2.

### Example 2

To the tee of Example 1 was applied a Danco stem repair washer having an outside diameter of 25/32 inch. The washer was obtained from Danco Corporation, 2727 Chemsearch Blvd., Irving, Tex., 75062. The washer has a center hole of about 3/16 inch in diameter, which permits it to be forced up the shank to just below the ball support cup and aggressively grip onto the shank with sufficient force that a golf club strike will not dislodge it. The material of the washer is neoprene 50-60 shore durometer. Of the three types of neoprene this one is type W, however, types G durometer (shore) A and T durometer (shore) D, which are softer and harder respectively can also be used by making sure the proper diameter is used for the shaft enlargement. A G type will need a larger diameter and T type can be a smaller diameter.

Natural and synthetic rubbers can be employed including: silicones, flurosilicones, fluroelastomers, nitriles, hypalons SBR red rubbers polyurethanes and many others. These materials can range from the quite soft to quite hard, having hardness numbers ranging from about 30 to about 90. As indicated above, the size of the shaft enlargement and the size range of its center hole depends on the diameter of the tee shank. All of this is within the skill of the art.

For greater visibility of the tee, the art of coloring aluminum is very well developed. For example, anodizing aluminum gives it a hard, transparent surface layer of aluminum oxide. This colorless layer permanently absorbs dyes and inks.

A tee of the preceding Example 1 was used experimentally by the inventor in over 100 rounds of golf at which time the washer was showing signs of fatigue. The washer was replaced and the tee is still in use. A second experimental tee was successfully used by Robert Hurley of Monarch Golf Club, Leesburg, Fla. in over 100 rounds of golf. These tests truly are evidence of a long lasting tee.

It is to be understood that the shank enlargement can be of different shapes, such as one side beveled, both sides beveled, cubic, spherical and so forth, so long as the diameter and thickness relationship is maintained. The length of the tee is important for several reasons. As indicated above, for the present day larger clubfaces of titanium and steel, tees should be longer to accommodate perching the ball where it is most likely to be struck at the sweet spot on the clubface. In addition, since this is a long lasting golf tee, it is important to take all reasonable steps to conveniently locate the tee after a ball has been struck. Therefore, the longer the tee the better, within permissible limits. The preferred length is from about 2⅞ inches to about 4 inches and particularly preferred is from about 3 to about 4 inches. This will permit the tee to be inserted well into a teeing area and thus be more apt to stay in place after a ball strike. In addition, the greater size, the greater the chance of immediately locating the tee after a ball strike, especially with present day colorization possibilities.

All patents, test procedures, and other documents cited herein, including priority documents, are fully incorporated by reference to the extent such disclosure is not inconsistent with this disclosure and for all jurisdictions in which such incorporation is permitted.

While the illustrative embodiments disclosed herein have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside herein, including all features which would be treated as equivalents thereof by those skilled in the art to which the disclosure pertains.

What is claimed is:

1. A long lasting golf tee for use when striking a golf ball, comprising:
a shank having a ground insertion tip at one end and a golf ball support structure at the other end, said shank formed of a member selected from the group consisting of aluminum and its physical equivalents for the intended purpose;
an enlargement positioned so as to encircle said shank below said golf ball support structure and located so as to be struck by a clubface of a golf club after the golf ball has been struck from said golf ball support structure, said enlargement having a diameter and a thickness;
wherein the diameter of said enlargement is larger than that of said golf ball support structure and smaller than the diameter of the golf ball, the thickness of said enlargement along said shank being less than the diameter; said enlargement being substantially elastic and having a resistance to compression sufficient to prevent the clubface of the golf club from impacting said golf ball support structure.

2. The golf tee of claim 1, wherein said shank comprises aluminum.

3. The golf tee of claim 2, wherein said aluminum comprises an alloy of primarily aluminum

4. The golf tee of claim 1, wherein said enlargement comprises a resilient material.

5. The golf tee of claim 4, wherein said shank comprises aluminum.

6. The golf tee of claim 4, wherein said resilient material comprises a natural or man-made resilient material.

7. The golf tee of claim 6, wherein said resilient material is neoprene.

8. The golf tee of claim 6, wherein said resilient material has a hardness of from about 30 to about 90 durometer.

9. The golf tee of claim 8, wherein said neoprene has a hardness of about 50 to about 60 durometer.

10. The golf tee of claim 9, wherein said shank comprises aluminum.

11. A method of making a long lasting golf tee for use when striking a golf ball, said method comprising the steps of:
(a) forming a shank having a ground insertion tip at one end and a golf ball support structure at the other, the shank being of a member selected from the group consisting of aluminum and its physical equivalents for the intended purpose; and
(b) positioning an enlargement so as to encircle the shank below the golf ball support structure and located so as to be struck by a clubface of a golf club after the golf ball has been struck from the golf ball support structure, the enlargement having a diameter and a thickness;
wherein the diameter of the enlargement is larger than that of the golf ball support structure and smaller than the diameter of the golf ball, the thickness of the enlargement along the shank being less than the diameter; the enlargement being substantially elastic and having a resistance to compression sufficient to prevent the clubface of the golf club from impacting the golf ball support structure.

12. The method of claim 11, wherein the shank comprises aluminum.

13. The method of claim 12, wherein the aluminum comprises an alloy of primarily aluminum.

14. The method of claim 11, wherein the enlargement comprises a resilient material.

15. The method of claim 14, wherein the shank comprises aluminum.

16. The golf tee of claim 14, wherein the resilient material comprises a natural or man-made resilient material.

17. The method of claim 16, wherein the resilient material is neoprene.

18. The method of claim 16, wherein the resilient material has a hardness of from about 30 to about 90 durometer.

19. The method of claim 18, wherein the neoprene has a hardness of about 50 to about 60 durometer.

20. The method of claim 19, wherein the shank comprises aluminum.
